(19) United States
(12) Patent Application Publication
(10) Pub. No.: US 2021/0132632 A1
(43) Pub. Date: May 6, 2021

(54) PHYSICAL QUANTITY SENSOR, ELECTRONIC APPARATUS, AND VEHICLE

(71) Applicant: SEIKO EPSON CORPORATION, Tokyo (JP)

(72) Inventor: Kazuyuki Nagata, Nagano-ken (JP)

(21) Appl. No.: 17/083,798

(22) Filed: Oct. 29, 2020

(30) Foreign Application Priority Data
Oct. 31, 2019 (JP) 2019-198377

(51) Int. Cl. G05D 1/08; G01P 15/125

(52) U.S. Cl. CPC G05D 1/08; G01P 15/125

(57) ABSTRACT

A physical quantity sensor includes a first plate, and a second plate opposed to the first plate via a gap, wherein a sensing area in which the gap between the first plate and the second plate changing with a physical quantity is detected based on a change of a capacitance is disposed in an area where the first plate and the second plate overlap each other in a plan view, the first plate is provided with a through hole in the sensing area, and in a part of the second plate where the second plate overlaps the through hole of the first plate in the plan view, a distance from the second plate to an imaginary plane extending in a same plane as a surface of the first plate opposed to the second plate via the gap is longer than a distance of the gap.

The present application is based on, and claims priority from JP Application Serial Number 2019-198377, filed Oct. 31, 2019, the disclosure of which is hereby incorporated by reference herein in its entirety.

### BACKGROUND

### 1. Technical Field

The present disclosure relates to a physical quantity sensor, an electronic apparatus, a vehicle, and so on.

### 2. Related Art

As a capacitance type physical quantity sensor, there are disclosed an acceleration sensor in JP-A-2012-229939 (Document 1), and a pressure sensor in JP-A-2019-075738 (Document 2). The acceleration sensor in Document 1 is provided with a detection plate disposed via a gap with a substrate, and the gap between the substrate and the detection plate changes with the acceleration. By detecting the capacitance changing with the size of the gap, the acceleration is detected. The pressure sensor in Document 2 has a diaphragm displaced with the pressure, and a back plate disposed via a gap with the diaphragm. The gap between the diaphragm and the back plate changes with the pressure. By detecting the capacitance changing with the size of the gap, the pressure is detected.

In the capacitance type physical quantity sensor, a gas such as air or an inert gas in a narrow space sandwiched between the two plates one of which is, for example, a stationary plate, and the other of which is, for example, a movable plate acts as a damping resistance for hindering the displacement of the movable plate. The damping resistance causes a thermal noise, and thus, acts as a noise source. Therefore, the detection plate (the movable plate) is provided with a plurality of through holes in the acceleration sensor, and the diaphragm (the movable plate) is provided with a plurality of through holes in the pressure sensor. Thus, the damping resistance is reduced.

However, the damping resistance acting as the noise source cannot sufficiently be reduced in some cases.

### SUMMARY

An aspect of the present disclosure relates to a physical quantity sensor including a first plate, and a second plate opposed to the first plate via a gap, wherein a sensing area in which the gap between the first plate and the second plate changing with a physical quantity is detected based on a change of a capacitance is disposed in an area where the first plate and the second plate overlap each other in a plan view, the first plate is provided with a through hole in the sensing area, and in a part of the second plate where the second plate overlaps the through hole of the first plate in the plan view, a distance from the second plate to an imaginary plane extending in a same plane as a surface of the first plate opposed to the second plate via the gap is longer than a distance of the gap.

### BRIEF DESCRIPTION OF THE DRAWINGS

FIG. 1 is a schematic perspective view showing a sensing area of a physical quantity sensor according to a first embodiment of the present disclosure.

FIG. 2 is a cross-sectional view along the line A-A shown in FIG. 1.

FIG. 3 is a characteristic diagram showing an effect of reducing a damping resistance by the first embodiment.

FIG. 4 is a diagram showing a modified example of a shape of a recessed part shown in FIG. 2.

FIG. 5 is a diagram showing a modified example in which the size of the recessed part shown in FIG. 2 is increased.

FIG. 6 is a characteristic diagram showing an effect of reducing a damping resistance by the embodiment shown in FIG. 5.

FIG. 7 is a diagram showing a modified example in which a through hole is provided to a movable plate having a stacked structure.

FIG. 8 is a diagram showing a modified example in which a recessed part is provided to an electrode layer of a substrate having a stacked structure.

FIG. 9 is a diagram showing a modified example in which an opening part is provided to an electrode layer of a substrate having a stacked structure.

FIG. 10 is a diagram showing a modified example in which an opening part is provided to an electrode layer of a substrate having a stacked structure, and a recessed part is provided to an insulating layer as a lower layer of the substrate.

FIG. 11 is a diagram showing a modified example in which a recessed part is provided to an insulating layer as a lower layer of a substrate having a stacked structure, and an electrode layer is disposed on the insulating layer.

FIG. 12 is a schematic cross-sectional view showing a sensing area of a physical quantity sensor according to a second embodiment of the present disclosure.

FIG. 13 is a plan view of a seesaw type acceleration sensor to which the physical quantity sensor according to the present disclosure is applied.

FIG. 14 is a cross-sectional view along the line B-B shown in FIG. 13.

FIG. 15 is a block diagram of an electronic apparatus according to another embodiment of the present disclosure.

FIG. 16 is a diagram showing an example of a vehicle according to still another embodiment of the present disclosure.

FIG. 17 is a block diagram showing a configuration example of the vehicle.

### DESCRIPTION OF EXEMPLARY EMBODIMENTS

The present embodiments will hereinafter be described. It should be noted that the present embodiments described below do not unreasonably limit the contents set forth in the appended claims. Further, all of the constituents described in the present embodiments are not necessarily essential elements.

### 1. First Embodiment

### 1.1. Sensing Area of Physical Quantity Sensor

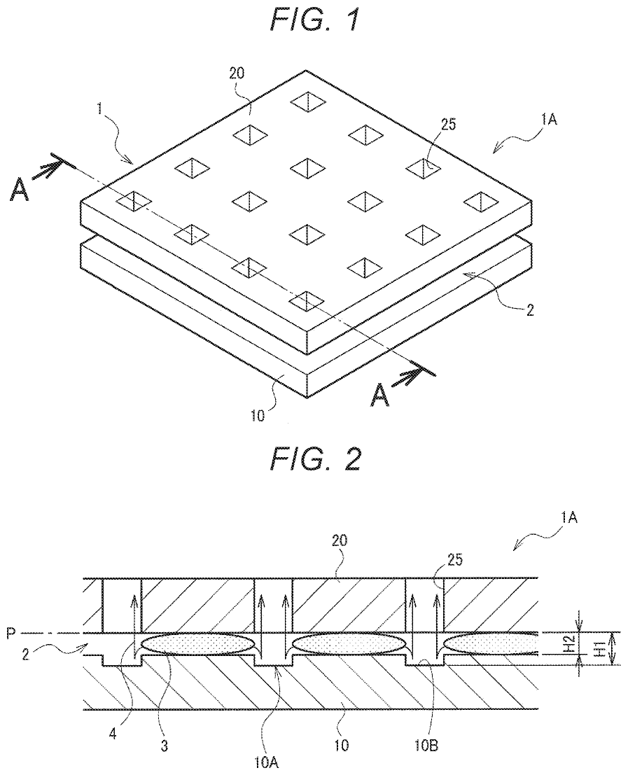

FIG. 1 shows a sensing area 1A of a physical quantity sensor 1 according to a first embodiment. In the sensing area 1A, a substrate 10 and a movable plate 20 are disposed via a gap 2. In the example shown in FIG. 1, the movable plate 20 moves upward or downward with respect to the substrate 10, which is stationary, in accordance with a physical quantity acting thereon to change the gap 2 between the two plates 10, 20. The capacitance type physical quantity sensor 1 detects the capacitance changing in accordance with the gap 2 between the substrate 10 and the movable plate 20 in the sensing area 1A to thereby detect the physical quantity. Therefore, the opposed surfaces of the two plates 10, 20 function as electrodes. It should be noted that it is sufficient for at least one of the two plates 10, 20 to move, and it is also possible for both of the two plates 10, 20 to move. Here, the physical quantity includes an inertial force such as a Coriolis force with respect to acceleration or angular velocity, and pressure, a vibration, and so on other than the inertial force.

As shown in FIG. 1, a plurality of through holes 25 is provided to, for example, the movable plate 20 in order to reduce a damping resistance formed by the air or an inert gas as a gas in the gap 2 which is narrow and is sandwiched between the two plates 10, 20. As a hole shape of the through hole 25, there can be adopted a circular shape, a quadrangular shape, an ellipse, a polygonal shape, and so on in a plan view. Out of the two plates 10, 20, when the movable plate 20 provided with the through holes 25 is referred to as a first plate, the substrate 10 is referred to as a second plate.

As shown in FIG. 2, in a part 10A of the substrate 10 where the substrate 10 overlaps the through hole 25 of the movable plate 20, a distance H1 from the substrate 10 to an imaginary plane P extending in the same plane as a surface of the movable plate 20 opposed to the substrate 10 via a gap is longer than the distance H2 of the gap 2. In other words, the substrate 10 has a recessed part 10B in the surface opposed to the movable plate 20 in the part 10A where the substrate 10 overlaps the through hole 25 of the movable plate 20 in the plan view. It should be noted that the distance H1 from the imaginary plane P to the substrate 10 is the shortest distance from the imaginary plane P to the substrate 10 in the part 10A where the substrate 10 overlaps the through hole 25 of the movable plate 20 in the plan view. Further, the distance H2 of the gap 2 is the shortest distance between the movable plate 20 and the substrate 10.

When the movable plate 20 moves in accordance with the physical quantity acting thereon to narrow the gap 2, the gas 3 located in the gap 2 moves along the arrows 4 schematically shown in FIG. 2, and then gets out from the through holes 25 of the movable plate 20. On this occasion, in order for the gas 3 to get out from the through hole 25, it is necessary for the gas 3 located between the two plates 10, 20 to once move to a position immediately below the through hole 25. The recessed part 10B provided to the substrate 10 makes the area immediately below the through hole 25 (H1-H2) wider than the distance H2 of the gap 2. Thus, the channel resistance of the gas 3 moving along the arrow 4 is reduced. Therefore, it becomes easy for the gas 3 located between the two plates 10, 20 to move to the position immediately below the through hole 25, and thus, the damping resistance is reduced. As described above, the damping resistance which causes the thermal noise and acts as the noise source is reduced without providing excessively large number of through holes 25.

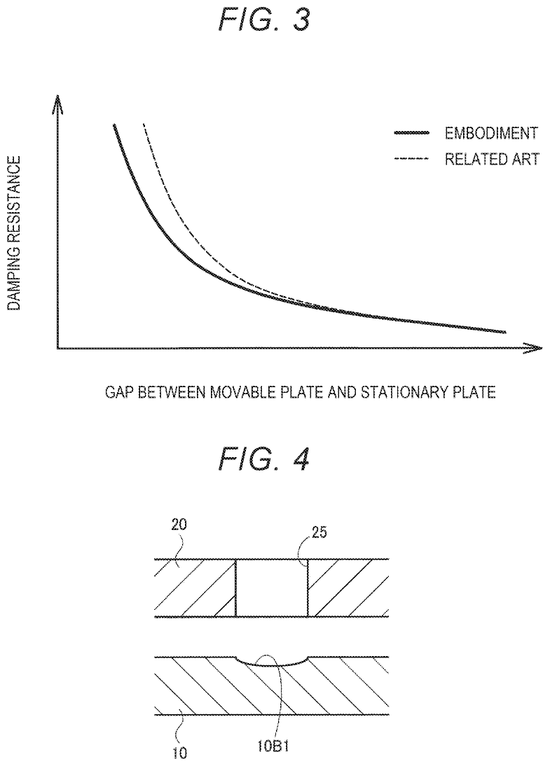

FIG. 3 is a characteristic diagram regarding the present embodiment with the recessed parts 10B and the related art without the recessed parts wherein the horizontal axis represents the distance H2 of the gap 2, and the vertical axis represents the value of the damping resistance. As shown in FIG. 3, it is understood that the narrower the gap 2 between the two plates 10, 20 is, the larger the damping resistance is, but the effect of reducing the damping resistance due to the recessed part 10B is high in a range in which the gap 2 is narrow. For this reason, the distance H2 of the gap 2 in the initial state in which the physical quantity does not act is preferably no larger than 5.0 μm. Taking the lower limit larger than 0, the distance H2 of the gap 2 in the initial state is 0.1 μm≤H2≤5.0 μm.

### 1.2. Modified Examples

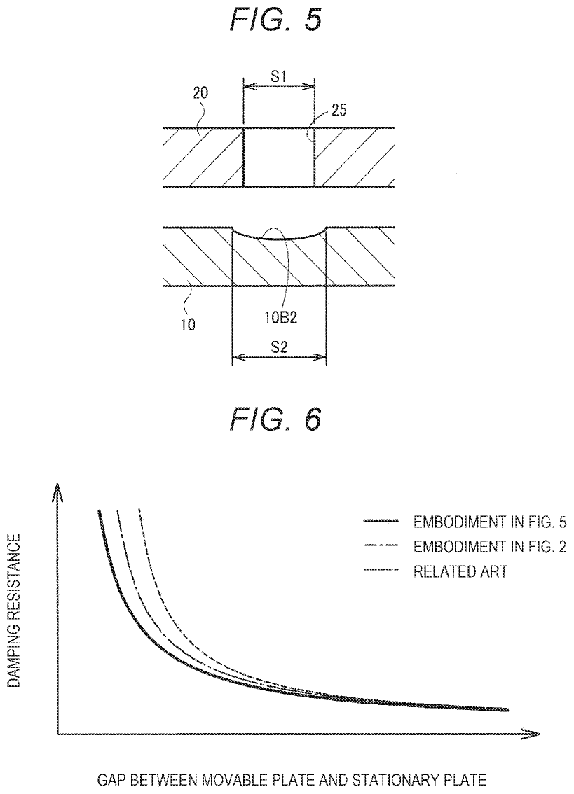

Here, there can be made a variety of practical modifications of the structure shown in FIG. 2. The interior circumferential wall of the recessed part 10B, which is vertical as shown in FIG. 2, can be modified as shown in FIG. 4. FIG. 4 shows the recessed part 10B1 in which the depth of the circumferential edge in the plan view is made shallower than the depth of the center in the plan view. In FIG. 4, the interior wall of the recessed part 10B1 is formed of a curved surface, but can also be formed of a tilted surface. In the recessed part 10B1 shown in FIG. 4, since the interior wall surface is curved or tilted, the curved surface or the tilted surface guides the gas 3 located between the two plates 10, 20 to smoothly move to the area immediately below the through hole 25. Therefore, it can be said that the recessed part 10B1 shown in FIG. 4 is higher in effect of reducing the damping resistance than the recessed part 10B shown in FIG. 2. The diameter of the recessed part 10B shown in FIG. 2 is roughly the same as the inner diameter of the through hole 24, but can be enlarged as that of the recessed part 10B2 shown in FIG. 5. In FIG. 5, denoting the opening space of the through hole 25 by S1, and the area of the recessed part 10B2 in the plan view by S2, S1<S2 is true. It should be noted that since S1=S2 is also possible as shown in FIG. 2, preferably S1≤S2, more preferably S1≤S2<2×S1, can be made true. This is because, when the area S2 of the recessed part 10B2 becomes less than the lower limit S1 of the inequality described above, the effect of reducing the damping resistance becomes inferior. This is because, when the area S2 of the recessed part 10B2 exceeds the upper limit (2×S1) of the inequality described above, an increase in the effect of reducing the damping resistance is small, and further, the sensitivity is sacrificed. It should be noted that on the shape of the interior wall of the recessed part B2 thus enlarged in FIG. 5, there can be made a variety of practical modification such as a shape including the vertical wall shown in FIG. 2.

FIG. 6 shows the effect of reducing the damping resistance due to the recessed part 10B2 shown in FIG. 5. As shown in FIG. 6, the effect of reducing the damping resistance due to the recessed part 10B2 shown in FIG. 5 is higher than the effect of reducing the damping resistance due to the recessed part 10B shown in FIG. 2. The reason therefor is that the area S2 of the recessed part 10B2 shown in FIG. 5 is larger than the area of the recessed part 10B shown in FIG. 2, and therefore, it becomes easier for the gas 3 located between the two plates 10, 20 to move to the position immediately below the through hole 25.

In order for the opposed surfaces of the two plates 10, 20 to function as the electrodes, it is possible to form both of the two plates 10, 20 from electrode plates, but this is not a limitation. It is possible to adopt a configuration in which one of the two plates 10, 20 is an electrode plate, the other of the two plates 10, 20 includes a stacked structure of an insulating layer and an electrode layer, and the electrode layer is disposed on the surface opposed to the electrode plate.

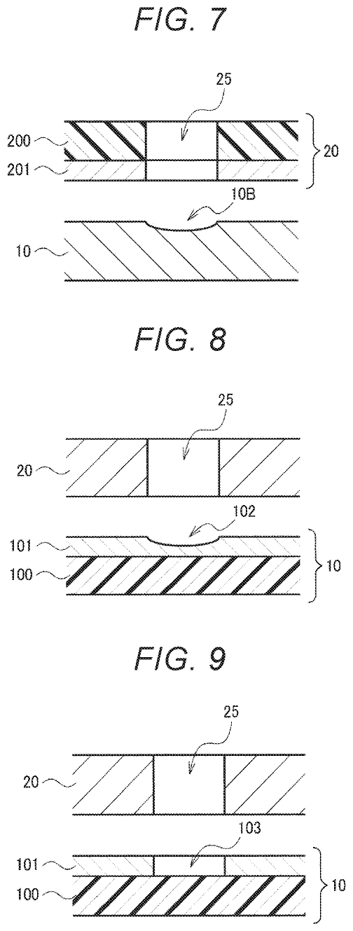

In FIG. 7, the substrate 10 is formed of an electrode plate such as a plate made of silicon provided with electrical conductivity by doping impurities such as phosphorus or boron, or a metal plate. The movable plate 20 includes a stacked structure of an insulating layer 200 and an electrode layer 201. The insulating layer 200 is made of, for example, glass or ceramic, or can also be formed of a silicon oxide layer formed on a silicon substrate. The electrode layer 201 can be formed of a metal layer or the like. In FIG. 7, the through holes 25 are provided to the movable plate 20 so as to penetrate the insulating layer 200 and the electrode layer 201.

In FIG. 8 through FIG. 11, the movable plate 20 is formed of an electrode plate such as a plate made of silicon provided with electrical conductivity by doping impurities such as phosphorus or boron, or a metal plate. The substrate 10 includes a stacked structure of an insulating layer 100 and an electrode layer 101. The insulating layer 100 is made of, for example, glass or ceramic, or can also be formed of a silicon oxide layer formed on a silicon substrate. The electrode layers 101 can be formed of, for example, a metal layer.

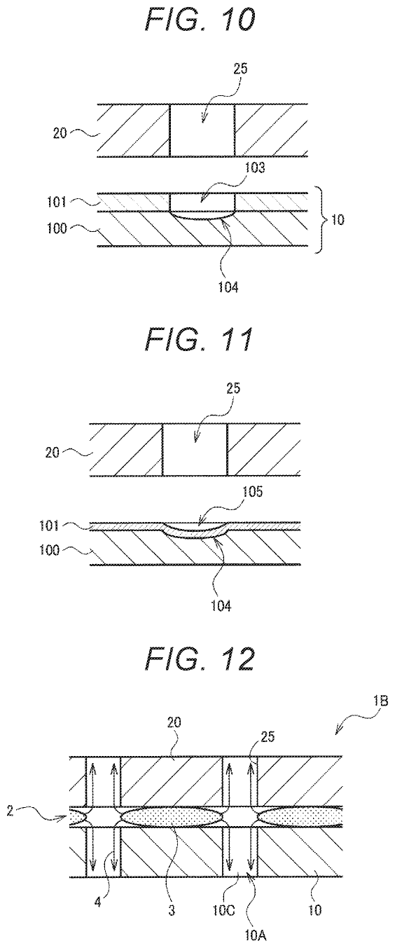

FIG. 8 shows an example in which a recessed part 102 is provided to the electrode layer 101 of the substrate 10. FIG. 9 shows an example in which an opening part 103 lacking the electrode layer is provided to the electrode layer 101 of the substrate 10. It is possible to make the opening part 103 function as the recessed part 10B shown in FIG. 2. FIG. 10 shows an example in which a recessed part 104 is provided to the insulating layer 100 within a range of the same opening part 103 shown in FIG. 9. In FIG. 10, it is possible to make the opening part 103 and the recessed part 104 function as the recessed part 10B shown in FIG. 2. In FIG. 11, the insulating layer 100 is provided with the recessed part 104, and the electrode layer 101 is formed on the insulating layer 100 with a substantially equal thickness. By forming the electrode layer 101 along the recessed part 104 of the insulating layer 100, a recessed part 105 is provided to the substrate 10.

### 1.3. Manufacturing Process

A manufacturing process of the recessed parts 10B, 10B1, 10B2, 102 through 105 shown in FIG. 2, FIG. 4, FIG. 5, and FIG. 7 through FIG. 11 will be described. In general, when forming the gap 2 as shown in FIG. 2, a sacrifice layer is formed on the substrate 10, then the movable plate 20 is formed on the sacrifice layer, and then the sacrifice layer is removed by etching using the through holes 25 of the movable plate 20. When using this manufacturing process, the recessed parts 10B, 10B1, 10B2, 102 through 105 shown in FIG. 2, FIG. 4, FIG. 5, and FIG. 7 through FIG. 11 can be formed by, for example, etching the substrate 10 before the sacrifice layer is formed. Here, the opening part 103 of the electrode layer 101 shown in FIG. 9 can be formed by detecting an endpoint in the etching process to stop the etching, or using an etching gas such high in selectivity as to etch the electrode layer 101 and not to etch the insulating layer 100. When forming the opening part 103 of the electrode layer 101 shown in FIG. 10 with etching, it is possible to provide the recessed part 104 to the insulating layer 100 with overetching. Alternatively, it is possible to form the recessed part 104 with etching using the opening part 103 as a mask after forming the opening part 103. It is sufficient for the electrode layer 101 shown in FIG. 11 to be formed after providing the recessed part 105 to the insulating layer 100.

It is also possible to, for example, bond the two plates 10, 20 disposed via the gap 2 to each other without using the sacrifice layer. In this case, it is also possible to form the through hole 25 and the recessed parts 10B, 10B1, 10B2, 102 through 104 shown in FIG. 2, FIG. 4, FIG. 5, and FIG. 7 through FIG. 10 after bonding the two plates 10, 20 to each other. For example, after bonding the two substrates 10, 20 to each other, the through holes 25 are provided to the movable plate 20 using dry etching such as reactive ion etching (RIE). On this occasion, the etching gas is supplied to the surface of the substrate 10 via the through holes 25 thus formed, and thus, the recessed parts 10B, 10B1, 10B2, 102 through 104 shown in FIG. 2, FIG. 4, FIG. 5, and FIG. 7 through FIG. 10 are formed. Moreover, when the gap 2 is narrow, the movable plate 20 having the through holes 25 functions as a mask, and thus, the recessed parts 10B, 10B1, 10B2, 102 through 104 can be formed at the corresponding positions with the corresponding shapes to the through holes 25. In this way, it is possible to form the recessed parts 10B, 10B1, 10B2, 102 through 104 in the formation process of the through holes 25. It should be noted that in order to form the recessed part 10B2 enlarge as shown in FIG. 5, it is sufficient to use the etching gas high in anisotropy with respect to the movable plate 20 and high in isotropy with respect to the substrate 10.

### 2. Second Embodiment

FIG. 12 shows a sensing area 1B of a physical quantity sensor 1 according to a second embodiment. In the sensing area 1B, there are disposed through holes 10C penetrating the substrate 10 instead of the recessed parts 10B shown in FIG. 2. Here, out of the two plates 10, 20, when the movable plate 20 provided with the through holes 25 is referred to as a first plate, the substrate 10 is referred to as a second plate. Further, the through holes 25 provided to the first plate 20 are each referred to as a first through hole, and the through holes 10C provided to the substrate 10 are each referred to as a second through hole.

The through holes 10C of the substrate 10 are disposed instead of the recessed parts 10B shown in FIG. 2, and the positions of the through holes 10C of the substrate 10 are each the part 10A where the substrate 10 overlaps the through hole 25 of the movable plate 20 in the plan view similarly to the recessed parts 10B. The through hole 10C and the through hole 25 can be made to have substantially the same opening space, or it is also possible to make either one through hole made to supplementarily function narrower in opening space than the other. Further, providing the through holes 10C and the through holes 25 overlap each other in the plan view, the planar shapes of the respective holes can be the same as, or different from, each other.

According to the embodiment shown in FIG. 12, when the movable plate 20 moves in accordance with the physical quantity acting thereon to decrease the distance of the gap 2, the gas 3 located in the gap 2 moves along the arrows 4 in the two, namely upper and lower, routes schematically shown in FIG. 12, and then gets out from the through holes 10C of the substrate 10 and the through holes 25 of the movable plate 20, respectively. As described above, the moving routes for the gas 3 are also ensured by the through holes 10C of the substrate 10, and therefore, it is possible to reduce the damping resistance. As described above, the damping resistance which causes the thermal noise and acts as the noise source is reduced without providing excessively large number of through holes 25.

It should be noted that regarding the second embodiment, both of the two plates 10, 20 can be formed of the electrode plates, but this is not a limitation. It is possible to adopt a configuration in which one of the two plates 10, 20 is an electrode plate, the other of the two plates 10, 20 includes a stacked structure of an insulating layer and an electrode layer, and the electrode layer is disposed on the surface opposed to the electrode plate.

In the manufacturing process of the physical quantity sensor according to the second embodiment, it is possible to use the sacrifice layer, or it is also possible to bond the two plates 10, 20 to each other without using the sacrifice layer similarly to the manufacturing process of the physical quantity sensor according to the first embodiment. Further, it is possible to provide the second through holes 10C to the substrate 10 using the first through holes 25 as a mask when performing the dry etching for providing the first though holes 25 to the movable plate 20 after bonding the two plates 10, 20 to each other without using the sacrifice layer.

### 3. Conclusion of Embodiments of Reducing Damping Resistance

As described above, the physical quantity sensor 1 according to the present embodiments has the first plate 20 and the second plate 10 opposed to the first plate 20 via the gap 2, the sensing area 1A for detecting the gap 2 between the first plate 20 and the second plate 10 changing with the physical quantity using the change in capacitance is disposed in the area where the first plate 20 and the second plate 10 overlap each other in the plan view, the first plate 20 is provided with the through holes 25 disposed in the sensing area 1A, and in the part 10A where the second plate 10 overlaps the through hole 25 of the first plate 20, the distance H1 from the second plate 10 to the imaginary plane P extending in the same plane as the surface of the first plate 20 opposed to the second plate 10 via the gap 2 is longer than the distance H2 of the gap 2 as shown in FIG. 2.

According to the present embodiments, in the part 10A where the second plate 10 overlaps the through hole 25 of the first plate 20, the area immediately below the through hole 25 is made (H1-H2) larger than the distance H2 of the gap 2. Thus, the channel resistance of the gas 3 moving along the arrow 4 is reduced. Therefore, it becomes easy for the gas 3 located between the two plates 10, 20 to move to the position immediately below the through hole 25, and thus, the damping resistance is reduced.

In the present embodiments, it is possible to adopt the configuration in which one of the first plate 20 and the second plate 10 is the electrode plate, the other of the first plate 20 and the second plate 10 includes the stacked structure of the insulating layer 100 (200) and the electrode layer 101 (201), and the electrode layer 101 (201) is disposed on the surface opposed to the electrode plate as shown in FIG. 7 and FIG. 8. Thus, it is possible to make the opposed surfaces of the two plates 10, 20 function as electrodes to realize the capacitance type physical quantity sensor.

In the present embodiments, it is possible to adopt the configuration in which the first plate 20 includes the stacked structure 200, 201, the second plate 10 is formed of the electrode plate, and in the part of the electrode plate overlapping the through hole 25 in the plan view, the electrode plate has the recessed part 10B on the surface opposed to the electrode layer 201 of the first plate 20 as shown in FIG. 7.

In the present embodiments, as shown in FIG. 8 through FIG. 11, it is possible for the second plate 10 to include the stacked structure 100, 101. In FIG. 8, it is possible for the electrode layer 101 of the second plate 10 to have the recessed part 102 on the surface opposed to the electrode plate in the part overlapping the through hole 25 in the plan view. In FIG. 9, it is possible for the electrode layer 101 of the second plate 10 to have the opening part 103 in the part overlapping the through hole 25 in the plan view. In FIG. 10, it is possible for the insulating layer 100 of the second plate 10 to additionally have the recessed part 104 on the surface opposed to the electrode plate 20 in the part overlapping the opening part 103 of the electrode layer 101 of the second plate 10. In FIG. 11, the insulating layer 100 of the second plate 10 has the recessed part 104 on the surface having contact with the electrode layer 101 in the part overlapping the through hole 25 in the plan view, and it is possible to form the electrode layer 101 so that the thickness is substantially equal between the part overlapping the through hole 25 and other parts than the part overlapping the through hole 25 in the plan view.

In the present embodiments, as shown in FIG. 4, the recessed part 10B1 can be formed so that the depth of the circumferential edge in the plan view is shallower than the depth of the center in the plan view. Thus, it is possible to guide the gas 3 located in the gap 2 between the two plates 10, 20 to move to the position opposed to the through hole 25.

In the present embodiments, as shown in FIG. 5, denoting the opening space of the through hole 25 by S1, and the area of the recessed part 10B2 in the plan view by S2, the inequality S1≤S2, more preferably the inequality S1≤S2<2×S1, can be made true. Thus, it is possible to effectively ensure the reduction in damping resistance.

Further, as shown in FIG. 12, the physical quantity sensor 1 according to the present embodiment has the first plate 20 and the second plate 10 opposed to the first plate 20 via the gap 2, the sensing area 1B for detecting the gap 2 between the first plate 20 and the second plate 10 changing with the physical quantity using the change in capacitance is disposed in the area where the first plate 20 and the second plate 10 overlap each other in the plan view, the first plate 20 is provided with the first through holes 25 disposed in the sensing area 1B, and the second plate 10 has the second through hole 10C in the part 10A where the second plate 10 overlaps the first through hole 25 of the first plate 20 in the plan view.

Thus, when, for example, the first plate 20 moves in accordance with the physical quantity acting thereon to decrease the distance of the gap 2, the gas 3 located in the gap 2 moves along the arrows 4 in the two, namely upper and lower, routes schematically shown in FIG. 12, and then gets out from the through holes 10C of the second plate 10 and the through holes 25 of the first plate 20, respectively. As described above, the moving routes for the gas 3 are also ensured by the through holes 10C of the second plate 10, and therefore, it is possible to reduce the damping resistance.

### 4. Specific Example of Physical Quantity Sensor

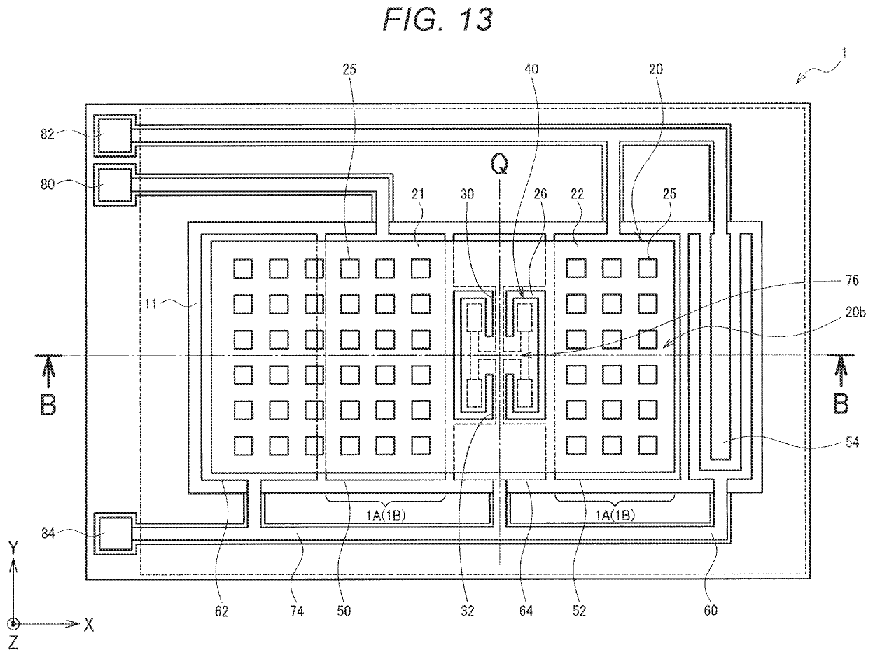

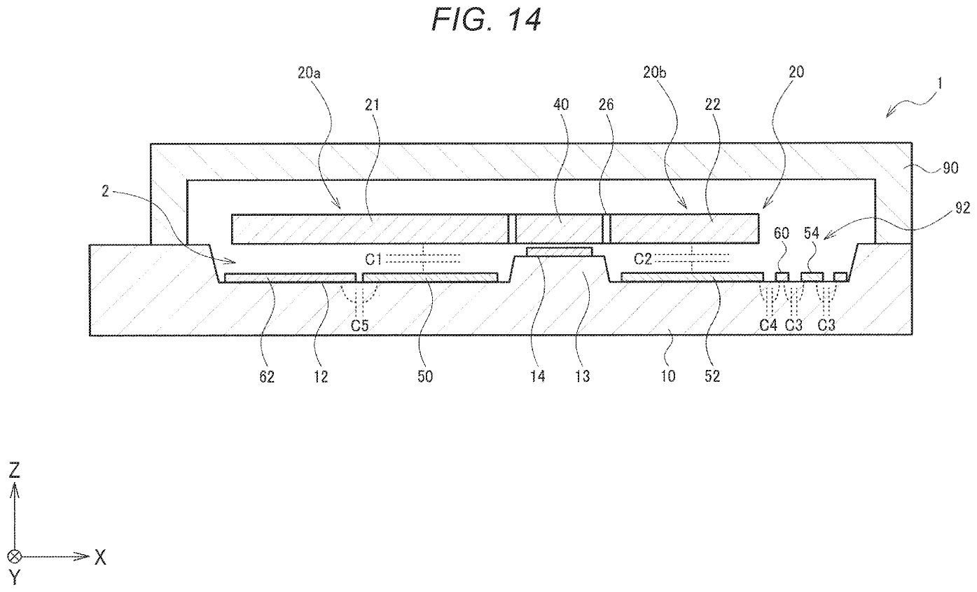

An embodiment in which the physical quantity sensor 1 according to the first embodiment or the second embodiment is applied to a seesaw type acceleration sensor (a capacitance type MEMS acceleration sensor) for detecting the acceleration in the vertical direction (the Z-axis direction) will hereinafter be described with reference to FIG. 13 and FIG. 14. The seesaw type acceleration sensor 1 has the substrate 10, and the movable plate 20 provided with the through holes 25 similarly to those shown in FIG. 1 through FIG. 2, FIG. 4 through FIG. 5, and FIG. 7 through FIG. 12. It should be noted that FIG. 14 is a cross-sectional view along the line B-B in FIG. 13, and the through hole 25 does not exist on the line B-B in FIG. 13. Therefore, in the cross-sectional view shown in FIG. 14, the through hole 25 and the recessed parts 10B, 10B1, 10B2, 102 through 105 which are located immediately below the through holes 25 and each shown in FIG. 2, FIG. 4, FIG. 5, and FIG. 7 through FIG. 11 are not shown.

The material of the substrate 10 is an insulating material such as glass. For example, by forming the substrate 10 from an insulating material such as glass, and forming the movable plate 20 from a semiconductor material such as silicon, the substrate 10 and the movable plate 20 can easily be electrically isolated from each other, and thus a sensor structure can be simplified.

The substrate 10 is provided with a recessed section 11. Above the recessed section 11, there are disposed the movable plate 20, and coupling sections 30, 32 to be coupled to the movable plate 20 via the gap 2. The substrate 10 has a post section 13 on a bottom surface 12 of the recessed section 11, wherein the post section 13 protrudes upward from the bottom surface 12. A first stationary electrode 50 is disposed on one of the both sides of the post section 13 shown in FIG. 14, and a second stationary electrode 52 is disposed on the other side. The first stationary electrode 50 is coupled to a first pad 80. The second stationary electrode 52 is coupled to a second pad 82 together with a third stationary electrode 54 provided to the substrate 10 at a position not opposed to the movable plate 20. In contrast, the movable plate 20 has a first movable electrode 21 overlapping the first stationary electrode 50 in a plan view, and a second movable electrode 22 overlapping the second stationary electrode 52 in the plan view. The movable plate 20 is formed of an electrically conductive material (e.g., silicon doped with an impurity).

A lid body 90 shown in FIG. 14 is bonded to the substrate 10. The lid body 90 and the substrate 10 form a cavity 92 for housing the movable plate 20. The cavity 92 is provided with, for example, an inert gas (e.g., a nitrogen gas) atmosphere. In this case, the gas 3 described with reference to FIG. 2 and so on corresponds to the inert gas.

Here, in FIG. 13, the area where the first movable electrode 21 and the first stationary electrode 50 overlap each other in the plan view and the area where the second movable electrode 22 and the second stationary electrode 52 overlap each other correspond to the sensing area 1A (1B) shown in FIG. 2 or FIG. 12. Therefore, the recessed parts 10B, 10B1, 10B2, 102 through 105 shown in FIG. 2, FIG. 4, FIG. 5, and FIG. 7 through FIG. 11 are provided to the first stationary electrode 50 and the second stationary electrode 52.

The movable plate 20 is displaced around a support axis Q in accordance with the physical quantity (e.g., the acceleration). Specifically, when the acceleration in the vertical direction (the Z-axis direction) is applied, the movable plate 20 makes the seesaw oscillation using the support axis Q determined by the coupling sections 30, 32 as a rotational axis (an oscillation axis). The support axis Q is parallel to, for example, the Y axis. The movable plate 20 has a first seesaw element 20a, and a second seesaw element 20b. The first seesaw element 20a is located on one side in a direction crossing the extending direction of the support axis Q in the plan view. The second seesaw element 20b is located on the other side in the direction crossing the extending direction of the support axis Q in the plan view.

Here, the support axis Q is disposed at a position shifted from the centroid of the movable plate 20 so that the rotational moment of the first seesaw element 20a and the rotational moment of the second seesaw element 20b are not balanced with each other to cause a predetermined tilt in the movable plate 20 when the acceleration in the vertical direction is applied. Thus, it is possible for the movable plate 20 to make the seesaw oscillation centering on the support axis Q when the acceleration in the vertical direction is applied.

In the movable plate 20, the first movable electrode 21 is provided to the first seesaw element 20a, and the second movable electrode 22 is provided to the second seesaw element 20b. The first movable electrode 21 forms a capacitance C1 with the first stationary electrode 50. The second movable electrode 22 forms a capacitance C2 with the second stationary electrode 52.

The capacitance C1 and the capacitance C2 are equal to each other when, for example, the movable plate 20 shown in FIG. 14 is in a horizontal state, and change in accordance with the positions of the movable electrodes 21, 22. The movable plate 20 is provided with a predetermined electrical potential via the coupling sections 30, 32 and a support section 40.

The movable plate 20 is provided with an opening part 26 penetrating the movable plate 26 on the support axis Q in the plan view. In the opening part 26, there are disposed the coupling sections 30, 32 and the support section 40. The movable plate 20 is coupled to the support section 40 via the coupling sections 30, 32 functioning as torsion springs. A part of the support section 40 is bonded to an upper surface 14 of the post section 13 with, for example, anodic bonding. It should be noted that although FIG. 14 is the cross-sectional view along the line B-B in FIG. 13, since a part of the support section 40 is bonded to the post section 13 at a planar position other than the cross-sectional surface along the line B-B in FIG. 13, the post section 13 is separated from the support section 40 in FIG. 14. The support section 40 supports the movable plate 20 via the coupling sections 30, 32.

In order to prevent the charge from being retained in the movable plate 20, dummy electrodes 60, 62, and 64 are disposed on the bottom surface 12 of the recessed section 11. The dummy electrodes 60, 62, and 64 are electrically coupled to the movable plate 20. The dummy electrodes 60, 62, and 64 have the same electrical potential as, for example, the movable plate 20. The first dummy electrode 60 fails to overlap the movable plate 20 in, for example, the plan view. The second and third dummy electrodes 62, 64 overlap the movable plate 20 in, for example, the plan view. Here, as shown in FIG. 13, the plurality of through holes 25 is also formed in the range of the movable plate 20 where the second dummy electrode 62 overlaps in the plan view. Therefore, it is possible to provide the recessed parts 10B, 10B1, 10B2, 102 through 105 shown in FIG. 2, FIG. 4, FIG. 5, and FIG. 7 through FIG. 11 also to the second dummy electrode 62 which overlaps the area where the through hole 25 is provided to the movable plate 20 in the plan view.

The first dummy electrode 60 forms a capacitance C3 with the third stationary electrode 54. Further, the first dummy electrode 60 forms a capacitance C4 with the second stationary electrode 52. The second dummy electrode 62 is disposed on one side in a direction crossing the extending direction of the support axis Q in the plan view. The second dummy electrode 62 overlaps the movable plate 20. In the illustrated example, the second dummy electrode 62 is electrically coupled to the movable plate 20 via a third interconnection 74, the third dummy electrode 64, a fourth interconnection 76, the support section 40, and the coupling sections 30, 32. The second dummy electrode 62 forms a capacitance C5 with the first stationary electrode 50. The third dummy electrode 64 forms a capacitance C6 (not shown) with the first stationary electrode 50. Further, the third dummy electrode 64 forms a capacitance C7 (not shown) with the second stationary electrode 52.

Then, an operation of the physical quantity sensor 1 will be described. In the physical quantity sensor 1, the movable plate 20 oscillates around the support axis Q in accordance with the physical quantity such as acceleration or angular velocity. Due to this action of the movable plate 20, the distance between the first movable electrode 21 and the first stationary electrode 50, and the distance between the second movable electrode 22 and the second stationary electrode change. Specifically, when the acceleration in, for example, a vertically upward direction (+Z-axis direction) is applied to the physical quantity sensor 1, the movable plate 20 rotates counterclockwise to decrease the distance between the first movable electrode 21 and the first stationary electrode 50, and increase the distance between the second movable electrode 22 and the second stationary electrode 52. As a result, the capacitance C1 increases, and the capacitance C2 decreases. Further, when the acceleration in, for example, a vertically downward direction (−Z-axis direction) is applied to the physical quantity sensor 1, the movable plate 20 rotates clockwise to increase the distance between the first movable electrode 21 and the first stationary electrode 50, and decrease the distance between the second movable electrode 22 and the second stationary electrode 52. As a result, the capacitance C1 decreases, and the capacitance C2 increases.

In the physical quantity sensor, the sum (a first capacitance) of the capacitance C1, the capacitance C5, and the capacitance C6 is detected using the pads 80, 84. Further, in the physical quantity sensor 1, the sum (a second capacitance) of the capacitance C2, the capacitance C3, the capacitance C4, and the capacitance C7 is detected using the pads 82, 84. Further, it is possible to detect the physical quantity such as a direction or the magnitude of the acceleration, the angular velocity, and so on using a differential detection method based on the difference between the first capacitance and the second capacitance. In such a manner, it is possible to use the physical quantity sensor 1 as an inertial sensor such as an acceleration sensor or a gyro sensor.

### 5. Electronic Apparatus, Vehicle

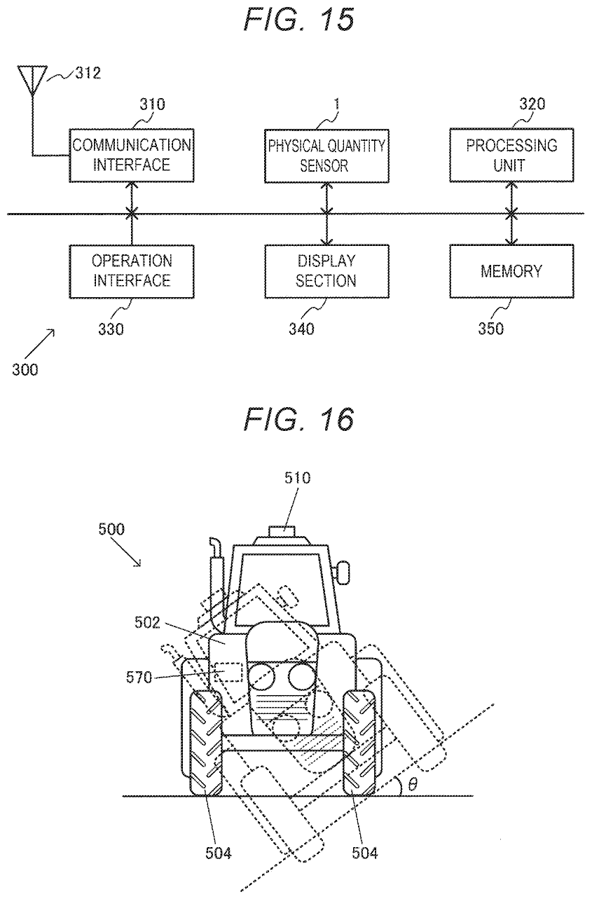

FIG. 15 is a block diagram showing a configuration example of an electronic apparatus 300 according to the present embodiment. The electronic apparatus 300 includes the physical quantity sensor 1 having the inertial sensor according to any of the embodiments described above, and a processing unit 320 for performing processing based on the measurement result of the physical quantity sensor 1. Further, the electronic apparatus 300 can include a communication interface 310, an operation interface 330, a display section 340, a memory 350, and an antenna 312.

The communication interface 310 is, for example, a wireless circuit, and performs a process of receiving data from the outside and transmitting data to the outside via the antenna 312. The processing unit 320 performs a control process of the electronic apparatus 300, a variety of types of digital processing of the data transmitted or received via the communication interface 310. Further, the processing unit 320 performs the processing based on the measurement result of the physical quantity sensor 1. Specifically, the processing unit 320 performs signal processing such as a correction process or a filter process on the output signal as the measurement result of the physical quantity sensor 1, or performs a variety of control processes with respect to the electronic apparatus 300 based on the output signal. The function of the processing unit 320 can be realized by a processor such as an MPU or a CPU. The operation interface 330 is for the user to perform an input operation, and can be realized by operation buttons, a touch panel display, or the like. The display section 340 is for displaying a variety of types of information, and can be realized by a display using a liquid crystal, an organic EL, or the like. The memory 350 is for storing the data, and the function thereof can be realized by a semiconductor memory such as a RAM or a ROM, or the like.

It should be noted that the electronic apparatus 300 according to the present embodiment can be applied to a variety of equipment such as an in-car apparatus, a video-related apparatus such as a digital still camera or a video camera, a wearable apparatus such as a head-mounted display device or a timepiece-related apparatus, an inkjet-type ejection device, a robot, a personal computer, a portable information terminal, a printer, a projection apparatus, a medical instrument, or a measurement instrument. The in-car apparatus is a car navigation system, an apparatus for automated driving, or the like. The timepiece-related apparatus is a timepiece, a smart watch, or the like. As the inkjet-type ejection device, there can be cited an inkjet printer and so on. The portable information terminal is a smartphone, a cellular phone, a portable gaming device, a notebook PC, a tablet terminal, or the like.

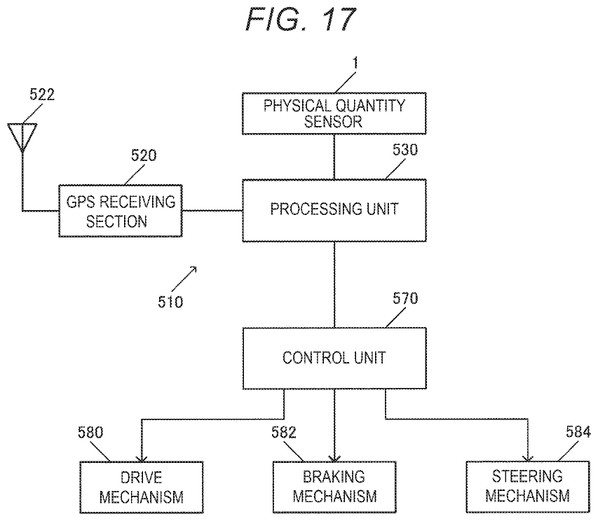

FIG. 16 shows an example of a vehicle 500 in which the physical quantity sensor 1 according to the present embodiment is used. FIG. 17 is a block diagram showing a configuration example of the vehicle 500. As shown in FIG. 17, the vehicle 500 according to the present embodiment includes the physical quantity sensor 1 and a processing unit 530 for performing processing based on the measurement result of the physical quantity sensor 1.

Specifically, as shown in FIG. 16, the vehicle 500 has a car body 502 and wheels 504. Further, a positioning unit 510 is installed in the vehicle 500. Further, a control unit 570 for performing vehicle control and so on is disposed inside the vehicle 500. Further, as shown in FIG. 17, the vehicle 500 has a drive mechanism 580 such as an engine or a motor, a braking mechanism 582 such as a disk brake or a drum brake, and a steering mechanism 584 realized by a steering wheel, a steering gearbox, and the like. As described above, the vehicle 500 is an apparatus or a unit which is provided with the drive mechanism 580, the braking mechanism 582, and the steering mechanism 584, and moves on the land, in the air, or on the sea. It should be noted that as the vehicle 500, there can be cited an automobile such as a four-wheeled vehicle or a motor bike, a bicycle, an electric train, an airplane, a ship, and so on, but in the present embodiment, the description will be presented citing the four-wheeled vehicle as an example.

The positioning unit 510 is a unit which is installed in the vehicle 500 to perform the positioning of the vehicle 500. The positioning unit 510 includes the physical quantity sensor 1 and the processing unit 530. Further, it is possible for the positioning unit 510 to include a GPS receiving section 520 and an antenna 522. The processing unit 530 as a host device receives acceleration data and angular velocity data as the measurement result of the physical quantity sensor 1, and then performs the inertial navigation arithmetic processing on these data to output inertial navigation positioning data. The inertial navigation positioning data is data representing the acceleration and the attitude of the vehicle 500.

The GPS receiving section 520 receives a signal from a GPS satellite via the antenna 522. The processing unit 530 obtains the GPS positioning data representing the position, the speed, and the azimuth of the vehicle 500 based on the signal received by the GPS receiving section 520. Further, the processing unit 530 calculates what position on the land the vehicle 500 is running using the inertial navigation positioning data and the GPS positioning data. For example, even when the position of the vehicle 500 included in the GPS positioning data is the same, when the attitude of the vehicle 500 is different due to the influence of the tilt (θ) of the land and so on as shown in FIG. 16, it results in that the vehicle 500 is running at a different position on the land. Therefore, it is unachievable to calculate the accurate position of the vehicle 500 with the GPS positioning data alone. Therefore, the processing unit 530 calculates what position on the land the vehicle 500 is running using in particular the data related to the attitude of the vehicle 500 out of the inertial navigation positioning data.

The control unit 570 performs the control of the drive mechanism 580, the braking mechanism 582, and the steering mechanism 584 of the vehicle 500. The control unit 570 is a controller for the vehicle control, and performs a variety of types of control such as the vehicle control and the automated driving control.

The vehicle 500 according to the present embodiment includes the physical quantity sensor 1 and the processing unit 530. The processing unit 530 performs a variety of processes as described above to obtain the information of the position and the attitude of the vehicle 500 based on the measurement result from the physical quantity sensor 1. For example, the information of the position of the vehicle 500 can be obtained based on the GPS positioning data and the inertial navigation positioning data as described above. Further, the information of the attitude of the vehicle 500 can be obtained based on, for example, the angular velocity data included in the inertial navigation positioning data. Further, the control unit 570 performs the control of the attitude of the vehicle 500 based on the information of the attitude of the vehicle 500 obtained by, for example, the processing by the processing unit 530. This control of the attitude can be realized by, for example, the control unit 570 controlling the steering mechanism 584. Alternatively, in the control such as slip control for stabilizing the attitude of the vehicle 500, it is possible for the control unit 570 to control the drive mechanism 580 or to control the braking mechanism 582. According to the present embodiment, since it is possible to accurately obtain the information of the attitude obtained by the output signal of the physical quantity sensor 1, it is possible to realize the appropriate attitude control and so on of the vehicle 500. Further, in the present embodiment, the automated driving control of the vehicle 500 can also be realized. In this automated driving control, there are used the monitoring result of a surrounding object, map information, driving route information, and so on in addition to the information of the position and attitude of the vehicle 500.

The electronic apparatus according to the present embodiment can be provided with the physical quantity sensor described above, and a control section for performing the control based on the detection signal output from the physical quantity sensor. By reducing the damping resistance generated in the sensing area of the physical quantity sensor, the noise in the detection signal from the physical quantity sensor is reduced, and thus, the reliability of the control of the electronic apparatus is enhanced.

The vehicle according to the present embodiment can be provided with the physical quantity sensor described above, and an attitude control section for performing the control of the attitude based on the detection signal output from the physical quantity sensor. By reducing the damping resistance generated in the sensing area of the physical quantity sensor, the noise in the detection signal from the physical quantity sensor is reduced, and thus, the reliability of the attitude control of the vehicle is enhanced.

What is claimed is:

1. A physical quantity sensor comprising:
a first plate; and
a second plate opposed to the first plate via a gap, wherein
a sensing area in which the gap between the first plate and the second plate changing with a physical quantity is detected based on a change of a capacitance is disposed in an area where the first plate and the second plate overlap each other in a plan view,
the first plate is provided with a through hole in the sensing area, and
in a part of the second plate where the second plate overlaps the through hole of the first plate in the plan view, a distance from the second plate to an imaginary plane extending in a same plane as a surface of the first plate opposed to the second plate via the gap is longer than a distance of the gap.

2. The physical quantity sensor according to claim 1, wherein
one of the first plate and the second plate is an electrode plate, another of the first plate and the second plate includes a stacked structure of an insulating layer and an electrode layer, and the electrode layer is disposed on a surface opposed to the electrode plate.

3. The physical quantity sensor according to claim 2, wherein
the first plate includes the stacked structure, and the second plate is the electrode plate, and
in a part of the electrode plate overlapping the through hole in the plan view, the electrode plate has a recessed part on a surface opposed to the electrode layer of the first plate.

4. The physical quantity sensor according to claim 2, wherein
the first plate is the electrode plate, and the second plate includes the stacked structure, and
in a part of the electrode layer of the second plate overlapping the through hole in the plan view, the electrode layer of the second plate has a recessed part on a surface opposed to the electrode plate.

5. The physical quantity sensor according to claim 2, wherein
the first plate is the electrode plate, and the second plate includes the stacked structure, and
the electrode layer of the second plate has an opening part in a part overlapping the through hole in the plan view.

6. The physical quantity sensor according to claim 5, wherein
in a part of the insulating layer of the second plate overlapping the opening part in the plan view, the insulating layer of the second plate has a recessed part on a surface opposed to the electrode plate.

7. The physical quantity sensor according to claim 2, wherein
the second plate includes the insulating layer and the electrode layer,
in a part of the insulating layer of the second plate overlapping the through hole in the plan view, the insulating layer of the second plate has a recessed part on a surface having contact with the electrode layer, and
the electrode layer of the second plate is substantially equal in thickness between apart overlapping the through hole in the plan view and other parts than the part overlapping the through hole.

8. The physical quantity sensor according to claim 3, wherein
in the recessed part, a depth on a circumferential edge in the plan view is shallower than a depth at a center in the plan view.

9. The physical quantity sensor according to claim 2, wherein
denoting an opening space of the through hole by S1, and an area of the recessed part in the plan view by S2, S1≤S2<2×S1 is true

10. A physical quantity sensor comprising:
a first plate; and
a second plate opposed to the first plate via a gap, wherein
a sensing area in which a distance between the first plate and the second plate changing with a physical quantity is detected based on a change of a capacitance is disposed in an area where the first plate and the second plate overlap each other in a plan view,
the first plate is provided with a first through hole in the sensing area, and
the second plate has a second through hole in a part where the second plate overlaps the first through hole in the plan view.

11. An electronic apparatus comprising:
the physical quantity sensor according to claim 1; and
a control section configured to perform control based on a detection signal output from the physical quantity sensor.

12. A vehicle comprising:
the physical quantity sensor according to claim 1; and
an attitude control section configured to perform control of an attitude based on a detection signal output from the physical quantity sensor.
